(19) United States
(12) Patent Application Publication
(10) Pub. No.: US 2018/0345557 A1
(43) Pub. Date: Dec. 6, 2018

(54) REMOTE CONTROL SYSTEM FOR INJECTION MOLDING MACHINE

(71) Applicant: HANYANG ROBOTICS CO., LTD., INCHEON (KR)

(72) Inventors: JONG WON KANG, INCHEON (KR); WUNG HA JANG, INCHEON (KR)

(21) Appl. No.: 15/562,117

(22) PCT Filed: Dec. 23, 2016
(86) PCT No.: PCT/KR2016/015196

§ 371 Date: Sep. 27, 2017

(30) Foreign Application Priority Data
Dec. 23, 2016 (KR) 10-2016-0177550

(51) Int. Cl. B29C 45/76; B29C 45/42; G05B 19/05; B25J 13/00; B25J 11/00

(52) U.S. Cl. CPC B29C 45/7626; B29C 45/4225; G05B 19/05; B25J 13/006; B25J 11/005; G05B 2219/13164; B29C 2045/7633; B29C 2045/4275; B29C 2045/7606; B29C 2945/76993; B29C 2045/4266

(57) ABSTRACT

A remote control system to remotely control a take-out robot of an injection molding machine on a production site through network includes an injection molding machine to produce and convey injection molded products through the take-out robot. A remote controller transmits and receives the operation data of the take-out robot and the information data on the injection molding to and from the injection molding machine through the wireless internet. The remote controller remotely controls the injection molding machine based on the utilized operation data and information data. A control pendent connected to the injection molding machine remotely controls the take-out robot, performs three-dimensional graphic simulation for the previous operations before operating the take-out robot and for loading motions of the injection molded products, and stores and outputs the three-dimensional graphic images of the injection molded products, based on a previously stored remote control access program.

### TECHNICAL FIELD

The present invention relates to a system for remotely controlling a take-out robot of an injection molding machine on a production site through network, thereby providing easiness in production management, conveniences in control, and improvements in an industrial safety level, through convergence with information technology IT, to achieve high reliability.

### BACKGROUND ART

Generally, injection molding is a manufacturing process for injecting a plasticized molding material (synthetic resin) into a cavity of a mold, curing the molded part, and producing the molded part as a complete product, and in producing the products made of the synthetic resin, both of injection molding and extrusion molding have been widely used.

The injection molding is carried out generally by an automation system using an injection molding machine, and especially, the injection molding machine is provided with a take-out robot as automation equipment that is used to take out and convey an injection molded product if the mold is open. The take-out robot is repeatedly operated automatically along a previously set path to take out injection molded products.

The technology related to the system for controlling the injection molding machine is disclosed in Korean Patent Publication Laid-open No. 10-2016-0073858, which relates to a monitoring system for monitoring an injection molding machine through sensors capable of photographing the injection molding machine. The monitoring system includes at least one or more sensors disposed on the injection molding machine to photograph the injection molding machine and thus to output depth and color images thereof, and a monitoring device for receiving the depth and color images from the at least one or more sensors, displaying control images based upon the received images, performing a motion tracking function for recognizing the motions of an object through the depth and color images, and if a specific motion is recognized, outputting an event corresponding to the specific motion to the control images.

Various control systems for injection molding machines on the basis of the above-mentioned conventional practice have been developed, but they still have some technical problems to be solved.

In processes for taking out and conveying an injection molded product by the take-out robot of the injection molding machine, for example, the conventional systems do not integrally control the processes, perfectly, and accordingly, they cannot immediately recognize and handle the malfunctions of the take-out robot and unexpected accidents happened by a worker's mistake, thereby undesirably reducing productivity, causing difficulties in production management and inconveniences in control, and remarkably lowering an industrial safety level.

### PRIOR ART DOCUMENT

### Patent Document

Korean Patent Publication Laid-open No. 10-2016-0073858 (Dated on Jun. 27, 2016)

### DISCLOSURE

### Technical Problem

Accordingly, the present invention has been made in view of the above-mentioned problems occurring in the prior art, and it is an object of the present invention to provide a remote control system for an injection molding machine that is configured to have a controller and a control pendent adapted to control the operation of a take-out robot so that on the basis of a remote control access program stored in the control pendent, the remote control for the take-out robot can be performed, a previous operation simulation before the operation of the take-out robot can be performed to previously check the operational state of the take-out robot, the mold files stored in the injection molding machine are easily recognized by a worker through the stored modeling images of an injection molded product, an injection molded product loading motion graphic simulation is executed to utilize a previous loading function, and the take-out robot can be operated, without any trouble, through a spare control pendent or connection to a PC, if the control pendent becomes abnormal.

### Technical Solution

To accomplish the above-mentioned object, according to the present invention, there is provided a remote control system for an injection molding machine, the remote control system including: the injection molding machine adapted to produce injection molded products through injection molding and to take out and convey the produced injection molded products through a take-out robot, while transmitting and receiving operation data of the take-out robot and information data on the injection molding through wireless internet; a remote controller adapted to transmit and receive the operation data of the take-out robot and the information data on the injection molding to and from the injection molding machine through the wireless internet, to utilize the operation data of the take-out robot and the information data on the injection molding, and to remotely control the injection molding machine on the basis of the utilized operation data and information data; and a control pendent connected to the injection molding machine to remotely control the take-out robot, to perform three-dimensional graphic simulations for previous operations before the operation of the take-out robot and for the loading motions of the injection molded products, and to store and output the three-dimensional graphic images of the injection molded products, on the basis of a previously stored remote control access program.

### Advantageous Effects

According to the present invention, the remote control system for an injection molding machine is configured, through the control pendent, to perform the remote control for the take-out robot, to perform the previous operation simulations before the operation of the take-out robot to previously check the operational state of the take-out robot, to allow the mold files stored in the injection molding machine to be easily recognized by a worker through the stored modeling images of the injection molded products, to execute the injection molded product loading motion graphic simulation to utilize the previous loading function, and to allow the take-out robot to be operated, without any trouble, through a spare control pendent or connection to a PC, thereby improving productivity, achieving easiness in production management, and enhancing conveniences in control and an industrial safety level.

### DESCRIPTION OF DRAWINGS

FIG. 1 is a perspective view showing a remote control system for an injection molding machine according to the present invention.

FIG. 2 is a block diagram showing the control for the remote control system for an injection molding machine according to the present invention.

### BEST MODE FOR INVENTION

Hereinafter, an explanation on a remote control system for an injection molding machine capable of achieving high reliability according to the present invention will be in detail given with reference to the attached drawing.

Before the present invention is disclosed and described, it is to be understood that the disclosed embodiments are merely exemplary of the invention, which can be embodied in various forms. If it is determined that the detailed explanation on the well known technology related to the present invention makes the scope of the present invention not clear, the explanation will be avoided for the brevity of the description.

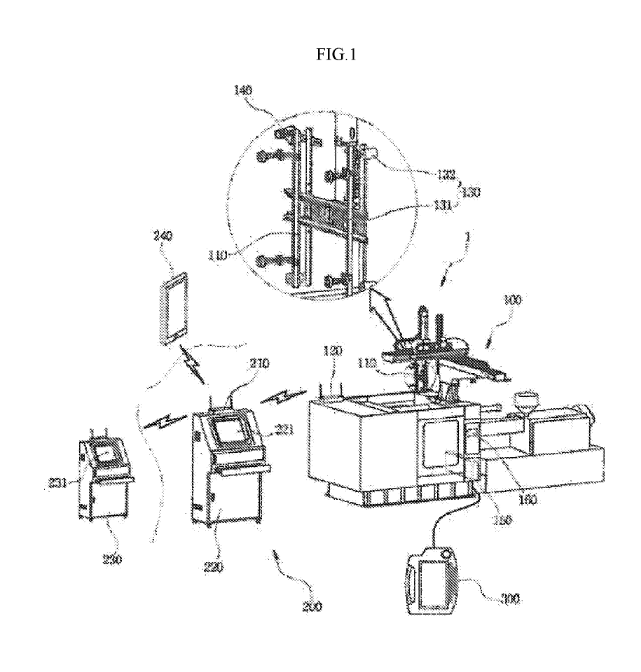

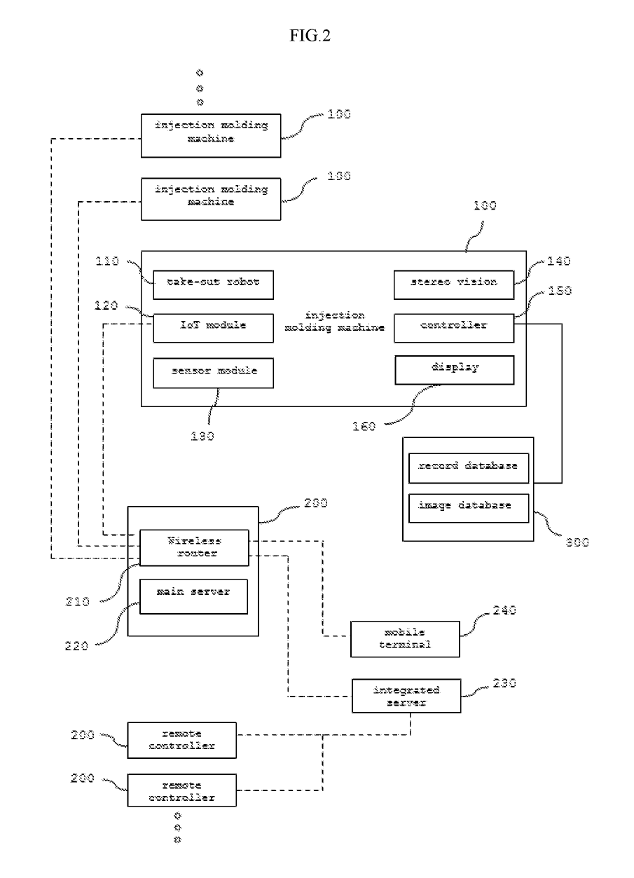

FIGS. 1 and 2 show a remote control system for an injection molding machine according to the present invention.

According to the present invention, a remote control system 1 for an injection molding machine 100 includes: the injection molding machine 100 for transmitting and receiving operation data of a take-out robot 110 and information data on injection molding through wireless internet; a remote controller 200 for remotely controlling the injection molding machine 100 on the basis of the operation data of the take-out robot 110 and the information data on the injection molding; and a control pendent 300 for remotely controlling the take-out robot 110, performing three-dimensional graphic simulations for the previous operations before the operation of the take-out robot 110 and for the loading motions of injection molded products, and storing and outputting the three-dimensional graphic images of the injection molded products.

Hereinafter, an explanation on the respective parts of the remote control system 1 for the injection molding machine according to the present invention will be in detail given with reference to FIGS. 1 and 2. FIG. 1 is a perspective view showing the remote control system according to the present invention, and FIG. 2 is a block diagram showing the control for the remote control system according to the present invention.

First, the injection molding machine 100 is adapted to produce the injection molded products through injection molding and to take out and convey the produced injection molded products through the take-out robot 110, while transmitting and receiving the operation data of the take-out robot 110 and the information data on the injection molding through wireless internet.

According to the present invention, the injection molding machine 100 basically includes the take-out robot 110, an IoT (Internet of Things) module 120, a sensor module 130, a stereo vision 140, a controller 150, and a display 160.

In more detail, the injection molding machine 100 includes the take-out robot 110 disposed thereon to take out and convey the produced injection molded products.

The take-out robot 110 is located at an arbitrary position of the injection molding machine 100 to take out and convey the injection molded products and performs linear reciprocation using one or more linear actuators in such a manner as to be movable in directions of X, Y and Z-axes. Of course, the structure of the take-out robot 110 may be variously changeable within the range applied to the injection molding machine 100.

At this time, each linear actuator reciprocates a moving guide through a motor and a screw, through a motor, a rack and a pinion, or through a solenoid electromagnet used for a mechanical movement.

Further, the injection molding machine 100 includes the IoT module 120 for wirelessly transmitting and receiving the operation data of the take-out robot 110 and the information data on the injection molding to and from the remote controller 200 through wireless internet.

The IoT module 120 is connected to the controller 150 through a hub and serves as a modem for transmitting and receiving the operation data of the take-out robot 110 and the information data on the injection molding to and from the remote controller 200 under a wireless communication environment.

At this time, the IoT module 120 integrally processes all kinds of information data on the injection molding of the injection molding machine 100 collected through the sensor module 130 and the stereo vision 140 under the controller 150, while providing the operation data of the take-out robot 110 and the information data on the injection molding to the remote controller 200.

Accordingly, the IoT module 120 can control the injection molding machine 100 on the basis of the Internet of Things.

Further, the injection molding machine 100 includes the sensor module 130 adapted to collect the information data on the injection molding by means of a load cell 131 and an infrared temperature sensor 132.

The sensor module 130 is connected to the controller 150 through the hub and provides all kinds of information data on the injection molding sensed by the injection molding machine 100 to the remote controller 200 under the wireless communication environment of the IoT module 120. Further, the sensor module 130 is located at an arbitrary position of the injection molding machine 100 to collect all information data on the injection molding of the injection molding machine 100.

At this time, the load cell 131 serves to measure a weight of each injection molded product, and in this case, the load cell 131 selectively has a weight change indicator (not shown) mounted thereon. The infrared temperature sensor 132 serves to measure the temperatures of the mold and the injection molded product of the injection molding machine 100.

Further, the injection molding machine 100 includes the stereo vision 140 for converting all processes of the injection molding into image data.

The stereo vision 140 is connected to the controller 150 through the hub and collects image information data obtained by in real time visualizing all situations on the injection molding of the injection molding machine 100 to provide the collected image information data to the remote controller 200 under the wireless communication environment of the IoT module 120. Further, the stereo vision 140 may have a high frequency fluorescent light HFFL, halogen lamp and so on having a local lighting function adapted to irradiate light onto the front thereof, thereby reducing flicker.

Further, the injection molding machine 100 includes the controller 150 based on a programmable logic controller PLC for storing and executing PLC programs needed in the injection molding.

The controller 150 programs and stores the signals inputted from a computer on the basis of the programmable logic controller, performs program correction and re-making for control commands through a microprocessor, and stores and utilizes all kinds of PLC programs needed in the operation of the injection molding machine 100.

At this time, the controller 150 receives and integrally processes the operation data of the take-out robot 110 of the injection molding machine 100 and the information data on the injection molding from the sensor module 130 and the stereo vision 140.

Further, the injection molding machine 100 includes the display 160 adapted to visualize and output all kinds of information data of the injection molding machine 100, and the display 160 has an HMI (Human Machine Interface) & MCD for performing the interfacing with the controller 150.

The display 160 is adapted to input the operation data of the take-out robot 110 and the information data on the injection molding through previously stored software.

Further, the remote controller 200 performs the transmission and reception of the data to and from the injection molding machine 100 through wireless internet, utilizes the operation data of the take-out robot 110 and the information data on the injection molding, and remotely controls the injection molding machine 100 on the basis of the utilized operation data and information data.

According to the present invention, the remote controller 200 basically includes a wireless router 210, a main server 220, an integrated server 230, and a mobile terminal 240.

In more detail, the remote controller 200 includes the wireless router 210 for performing communication with the injection molding machine 100 through wireless internet.

The wireless router 210 is a modem for wirelessly transmitting and receiving the operation data of the take-out robot 110 and the information data on the injection molding to and from the IoT module 120 of the injection molding machine 100 through wireless communication (Wi-Fi).

Further, the remote controller 200 includes the main server 220 connected to the wireless router 210 to intensively process the operation data of the take-out robot 110 and the information data on the injection molding, to output the data processed in real time through a main monitor 221, and to remotely control the injection molding machine 100 on a production site.

The main server 220 is located on the production site where the injection molding machine 100 operates in such a manner as to be connected to the wireless router 210 and processes the operation data of the take-out robot 110 and the information data on the injection molding received from the wireless router 210 under the control of a CCR (Commitment, Concurrency, and Recovery) computer, visually outputs the data through the main monitor 221, and transmits and receives all kinds of information data processed therein to the mobile terminal 240 and the integrated server 230 through wire/wireless communication service.

Further, the remote controller 200 includes the mobile terminal 240 adapted to receive the operation data of the take-out robot 110 and the information data on the injection molding through wireless communication service and to control the injection molding machine 100 in real time.

The mobile terminal 240 receives the operation data of the take-out robot 110 of the injection molding machine 100 and the information data on the injection molding from the main server 220 under the wireless communication environment of the wireless router 210 and utilizes the received data in real time at the outside of the production site on which the injection molding machine 100 operates. To this end, the mobile terminal 240 makes use of separate mobile application software through which the operation data of the take-out robot 110 and the information data on the injection molding are utilized.

The manager who is not on the production site checks all kinds of information data processed in the main server 220 through his or her mobile terminal 240, that is, his or her smartphone, in real time, so that even in the state where he or she does not exist on the production site, he or she can immediately treat substantially large operations to be processed in the main server 220.

Furthermore, the remote controller 200 includes the integrated server 230 adapted to receive the operation data of the take-out robot 110 and the information data on the injection molding from the main server 220 through wire/wireless communication service and to remotely control one or more injection molding machines 100 installed on the production site integrally on the side of a supplier who supplies the injection molding machines 100 to the production site.

The integrated server 230 is located on a place where a first supplier of the injection molding machines 100 is located and processes the operation data of the take-out robots 110 of the injection molding machines 100 and the information data on the injection molding received from the main server 220 under the control of a CCR (Commitment, Concurrency, and Recovery) computer, visually outputs the processed data through an integrated monitor 231, and transmits and receives all kinds of information data of the injection molding machines 100 operating on one or more production sites through wire/wireless communication service, thereby systematically controlling the injection molding machines 100 operating on one or more production sites.

Further, the control pendent 300 is connected to the injection molding machine 100 and is adapted to remotely control the take-out robot 110, to perform three-dimensional graphic simulations for the previous operations before the operation of the take-out robot 110 and for the loading motions of the injection molded products, and to store and output the three-dimensional graphic images of the injection molded products, on the basis of a previously stored remote control access program.

For example, the control pendent 300 includes a central processing unit CPU for processing all kinds of data, a memory unit for storing programs like the remote control access program, various software, or firmware, a display unit for visually outputting the processed data, and an input-output unit for inputting and outputting all kinds of data.

In this case, the control pendent 300 further includes a record database 310 for storing the operation data of the take-out robots 110 and the information data on the injection molding therein and an image database 320 for storing solution videos for troubles of the injection molding machine 100, a technology teaching video for a use method of the take-out robot 110, and a remote technology support video including user interface UI.

The record database 310 and the image database 320 are provided in the memory unit of the control pendent 300. If the operation data of the take-out robots 110 and the information data on the injection molding are provided to the control pendent 300, the record database 310 stores and utilizes the received data, and if all kinds of videos related to the operation of the injection molding machine 100 are made, the image database 320 stores and utilizes the image data of the videos.

If error data is detected from the operation data of the take-out robots 110 and the information data on the injection molding received from the main sever 220 on the production site, further, the control pendent 300 analyzes the error data, corrects, adds or deletes the operation data of the take-out robots 110 and the information data on the injection molding through the connection to the main server 220, and automatically recovers the trouble of the injection molding machine 100, on the basis of the previously stored remote control access program stored in the memory unit.

At this time, the remote control access program is software programmed to utilize the operation data of the take-out robots 110 and the information data on the injection molding, and through the utilization of the software, the trouble of the injection molding machine 100 is automatically recovered. The remote control access program includes a program for executing the previous operation simulations before the operation of the take-out robot 110, a program for executing storing of all kinds of modeling images of the injection molded products, and a program for executing an injection molded product loading motion graphic simulation.

Through the control pendent 300, accordingly, the remote control for the take-out robot 110 can be performed, the previous operation simulations before the operation of the take-out robot 110 can be performed to previously check the operational state of the take-out robot 110, the mold files stored in the injection molding machine 100 are easily recognized by the worker through the stored modeling images of the injection molded products, and the injection molded product loading motion graphic simulation is executed to utilize a previous loading function.

Further, the control pendent 300 enables the take-out robot 110 to be operated, without any trouble, through a spare control pendent 300 or connection to a PC, thereby improving productivity, achieving easiness in production management, and enhancing conveniences in the control and an industrial safety level.

The exemplary embodiments of the present invention have been described in detail with reference to the accompanying drawings, but the terms used in the description are defined in accordance with the functions of the present invention, but may be varied under the intention or regulation of a user or operator. Therefore, they should be defined on the basis of the whole scope of the present invention.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### EXPLANATION ON REFERENCE NUMERALS

1: remote control system 100: injection molding machine

110: take-out robot 120: IoT module

130: sensor module 140: stereo vision

150: controller 160: display

200: remote controller 210: wireless router

220: main server 230: integrated server

240: mobile terminal 300: control pendent

1-10. (canceled)

11. A remote control system for an injection molding machine, comprising:
the injection molding machine configured to produce injection molded products through an injection molding, to take out and convey the produced injection molded products through a take-out robot, while transmitting and receiving operation data of the take-out robot and information data on the injection molding through a wireless communications network;
a remote controller configured to transmit and receive the operation data of the take-out robot and the information data on the injection molding to and from the injection molding machine through the wireless communications network, to utilize the operation data of the take-out robot and the information data on the injection molding, and to remotely control the injection molding machine in accordance with the utilized operation data and information data; and
a control pendent connected to the injection molding machine to remotely control the take-out robot, to perform a three-dimensional graphic simulation for previous operations before a current operation of the take-out robot and for loading motions of the injection molded products, to store and output three-dimensional graphic images of the injection molded products, in accordance with a previously stored remote control access program.

12. The remote control system according to claim 11, wherein the control pendent comprises:
a record database to store the operation data of the take-out robot and the information data on the injection molding therein; and
an image database to store solution videos for troubleshooting the injection molding machine, a technology teaching video for operating the take-out robot, and a remote technology support video including a user interface.

13. The remote control system according to claim 11, wherein in response to a detection of an error data from the operation data of the take-out robot and the information data on the injection molding received from a main sever on a production site, the control pendent analyzes the error data and corrects, adds or deletes the operation data of the take-out robot and the information data on the injection molding through a connection to the main server, and automatically recovers the injection molding machine from a problem associated with the error data.

14. The remote control system according to claim 11, wherein the injection molding machine comprises an Internet of Things module configured to wirelessly transmit and receive the operation data of the take-out robot and the information data on the injection molding to and from the remote controller through the wireless communications network.

15. The remote control system according to claim 11, wherein the injection molding machine comprises a sensor module configured to collect the information data on the injection molding by a load cell and an infrared temperature sensor.

16. The remote control system according to claim 11, wherein the injection molding machine comprises a stereo vision configured to convert processes of the injection molding into image data.

17. The remote control system according to claim 11, wherein the injection molding machine comprises a controller based on a programmable logic controller to store and execute programmable logic controller programs for the injection molding.

18. The remote control system according to claim 11, wherein the remote controller comprises a wireless router configured to perform communications with the injection molding machine through the wireless communications network and a main server connected to the wireless router configured to intensively process the operation data of the take-out robot and the information data on the injection molding, to output information data processed in real time through a main monitor, and to remotely control the injection molding machine on a production site.

19. The remote control system according to claim 11, wherein the remote controller comprises a mobile terminal configured to receive the operation data of the take-out robot and the information data on the injection molding through the wireless communications network to control the injection molding machine in real time.

20. The remote control system according to claim 11, wherein the remote controller comprises an integrated server configured to receive the operation data of the take-out robot and the information data on the injection molding from a main server through the wireless communications network to remotely control one or more injection molding machines installed on a production site.
